(19) United States
(12) Patent Application Publication
(10) Pub. No.: US 2026/0048656 A1
(43) Pub. Date: Feb. 19, 2026

(54) Recreational Vehicle User Interface

(71) Applicant: Dometic Sweden AB, Solna (SE)

(72) Inventors: Ulf Landberger, Spanga (SE); Rickard Hederstierna, Hägersten (SE)

(21) Appl. No.: 19/368,475

(22) Filed: Oct. 24, 2025

Related U.S. Application Data
(63) Continuation of application No. 18/245,320, now Pat. No. 12,472,814.

(30) Foreign Application Priority Data
Sep. 18, 2020 (EP) 20197019.1

(51) Int. Cl. B60K 35/10; B60K 35/28; B60K 35/50; B60K 35/80; H05B 47/19

(52) U.S. Cl. CPC B60K 35/10; B60K 35/50; B60K 35/80; H05B 47/19; B60K 35/28; B60K 2360/11; B60K 2360/126; B60K 2360/1438; B60K 2360/1468; B60K 2360/162

(57) ABSTRACT

The present disclosure generally relates to a method implemented in a Recreational Vehicle User Interface (RVUI) and a corresponding RVUI for controlling one or several functions of a recreational vehicle (RV). A circular-shaped user input element is displayed at a touchscreen of the RVUI. Furthermore, a user input is detected at the touchscreen of the RVUI. This user input comprises a movement along the displayed circular-shaped user input element. The movement is indicative of a request to control a user-selected function of the recreational vehicle. The user-selected function includes any one or a combination of: a climate control function, a heater function, a ventilation function, a water heater function, a vehicle battery function, a light control function, and a security alarm function. Responsive to detecting this user input, control of the user-selected function is initiated, or otherwise triggered.

### CROSS REFERENCE TO RELATED APPLICATIONS

Any and all applications for which a foreign or domestic priority claim is identified in the Application Data Sheet as filed with the present application are hereby incorporated by reference herein and made a part of the present disclosure.

### TECHNICAL FIELD

The present disclosure generally relates to the field of vehicles and, in particular, recreational vehicles or recreational vessels.

More specifically, the present disclosure relates to user interfaces, e.g. being part of a recreational vehicle monitoring and control system, for controlling at least one function of a recreational vehicle or a recreational vessel.

### BACKGROUND

Recreational vehicles, commonly abbreviated RV, are vehicles which include living quarters for accommodation. Various types of recreational vehicles include, e.g., a motorhome, a campervan, a caravan, a fifth-wheel trailer, a pop-up camper, or a truck camper.

In recent years, the development of recreational vehicles, and their functions, has been intense. Nowadays, recreational vehicles are becoming increasingly complex, and more and more functions are added. These functions may include, but are not limited to, HVAC (Heat, Ventilation and Air-Conditioning) related functions, security alarm functions, light control functions, etc. Conventionally, the various functions have been controlled individually. That is, each function is controllable by a dedicated control device such that all controllable functions have different control devices.

When more and more functions are added to the recreational vehicle, the number of control devices also increases. This may result in an excessive number of control devices to control the many functions to be controlled in the recreational vehicle. This may be perceived as cumbersome by some users of the recreational vehicles.

### SUMMARY

It is in view of the above considerations and others that the various embodiments have been made by the inventors.

The present disclosure recognizes the fact that there is a need for an improved method and a corresponding user interface for controlling one or more functions in a recreational vehicle.

It is therefore a general object of the embodiments described herein to provide an improved method and a corresponding user interface for controlling at least one function of a recreational vehicle. It would be advantageous if the method and the user interface allows for controlling one or multiple functions flexibly. Additionally, or alternatively, it would be advantageous if the method and the user interface allows for controlling one or multiple functions without inducing unnecessary complexity to a user who desires to control said function(s). As will be appreciated, it would therefore also be advantageous if the method and the user interface improve the user-friendliness compared to the existing art described in the background.

The above-mentioned general object has been addressed by the appended independent claims. Advantageous embodiments are described in the appended dependent claims.

In a first of its aspects, the present disclosure presents a method implemented in a Recreational Vehicle User Interface (RVUI) for controlling at least one function of a recreational vehicle (RV). The RVUI may be part of, or otherwise comprised in, a RV monitoring and control system of the RV.

The method comprises displaying, at a touchscreen of the RVUI, a circular-shaped user input element; and detecting, at the touchscreen of the RVUI, a user input comprising a movement along the displayed circular-shaped user input element, the movement being indicative of a request to control a user-selected function of the recreational vehicle; and responsive to detecting said user input initiating control of the user-selected function.

The method may additionally comprise transmitting a control signal representative of the user-selected function to a processor for control of the user-selected function. The control signal may be transmitted wirelessly or via a wired connection.

In some embodiments, the method may additionally comprise animating, at the touchscreen of the RVUI, rotational movement of the user input along the displayed circular-shaped user input element in a manner that corresponds to the user movement.

Additionally, or alternatively, the method may comprise providing tactile feedback along the displayed circular-shaped user input element in a manner such that a user can sense his/her movement along the displayed circular-shaped user input element.

In some embodiments, the user-selected function may include any one or a combination of: a climate control function, a heater function, a ventilation function, a water heater function, a vehicle battery function, a light control function, and a security alarm function.

In some embodiments, the user-selected function may be selected prior to the detecting of said user input.

In some embodiments, the method may comprise providing, at the RVUI, at least one input region configured to receive a pressing input, the at least one input region being physically depressible upon receiving the pressing input thereat; wherein detecting a pressing input being indicative of a request to select said user-selected function of the recreational vehicle. In alternative embodiments, the method may comprise: displaying, at the touchscreen of the RVUI, at least one input region; and detecting a momentary pressing at the at least one input region and responsive thereto selecting said user-selected function of the recreational vehicle. For example, the momentary pressing may include a tap or a short press of the at least one input region.

In a second of its aspects, the present disclosure presents a Recreational Vehicle User Interface (RVUI) for controlling at least one function of a recreational vehicle (RV). The RVUI may be part of, or otherwise comprised in, a RV monitoring and control system of the RV.

The RVUI comprises a touchscreen configured to display a circular-shaped user input element; wherein the touchscreen is configured to detect a user input comprising a movement along the displayed circular-shaped user input element, the movement being indicative of a request to control a user-selected function of the recreational vehicle; and wherein the RVUI is further configured to initiate control of the user-selected function responsive to detecting said user input.

In some embodiments, the RVUI may additionally be configured to transmit a control signal representative of the user-selected function to a processor for control of the user-selected function. The control signal may be transmitted either wirelessly or via a wired connection.

In some embodiments, the touchscreen may be configured to animate rotational movement of the user input along the displayed circular-shaped user input element in a manner that corresponds to the user movement.

Additionally, or alternatively, the touchscreen may be configured to provide tactile feedback along the displayed circular-shaped user input element in a manner such that a user can sense his/her movement along the displayed circular-shaped user input element. The tactile feedback could, e.g., be implemented by using a vibration-creating device (e.g., a motor or the like) that is configured to create vibrations in response to user input in the form of the movement along the displayed circular-shaped user input element.

In some embodiments, the user-selected function may include any one or a combination of: a climate control function, a heater function, a ventilation function, a water heater function, a vehicle battery function, a light control function, and a security alarm function.

In some embodiments, the RVUI may comprise at least one input region configured to receive a pressing input, the at least one input region being physically depressible upon receiving the pressing input thereat; wherein the pressing input is indicative of a request to select said user-selected function of the recreational vehicle.

In some embodiments, the touchscreen of the RVUI may be configured to display at least one input region; wherein the touchscreen of the RVUI may be further configured to detect a momentary pressing at the at least one input region and responsive thereto to select said user-selected function of the recreational vehicle. For example, the momentary pressing may include a tap or a short press of the at least one input region.

In a third of its aspects, the present disclosure presents a user interface panel comprising the RVUI according to the second aspect. The user interface panel is attachable to a surface of the recreational vehicle. For example, the user interface panel may be removably attachable to the surface of the recreational vehicle.

In a fourth of its aspects, the present disclosure presents a recreational vehicle comprising the user interface panel according to the third aspect.

For example, the recreational vehicle may be a recreational vehicle selected from the group consisting of: a motorhome, a campervan, a caravan, a fifth-wheel trailer, a pop-up camper, a truck camper.

In a fifth of its aspects, the present disclosure presents a computer program, comprising instructions which, when executed on at least one processor, cause the at least one processor to carry out the method according to the first aspect. Furthermore, a carrier comprising the computer program of the fifth aspect may be provided. The carrier may for example be one of an electronic signal, an optical signal, a radio signal or non-transitory computer readable storage medium.

The various aspects and embodiments provide an improved method and a corresponding RVUI for controlling one or several functions of a recreational vehicle. Some aspects and embodiments allow for controlling one or multiple functions of the RV flexibly. For example, some aspects and embodiments allow for controlling one or multiple functions without inducing unnecessary complexity to a user who desires to control said function(s). Compared to the existing art, the proposed embodiments may be perceived as more user-friendly by some users.

### BRIEF DESCRIPTION OF THE DRAWINGS

These and other aspects, features and advantages will be apparent and elucidated from the following description of various embodiments, reference being made to the accompanying drawings, in which:

FIGS. 1A-1C illustrate flowcharts of a method according to some embodiments;

FIG. 2 illustrates an example implementation of a RV monitoring and control system including a RVUI;

FIG. 3 illustrates another example implementation of a RV monitoring and control system including a user interface panel;

FIG. 4 illustrates an example embodiment where the user interface panel including the RVUI is attached to a structure of a RV;

FIG. 5 illustrates an example of a RV, such as a motorhome;

FIG. 6 illustrates a carrier containing a computer program, in accordance with some embodiments;

FIGS. 7A-7B illustrate various conceivable example embodiments of a RVUI; and

FIGS. 8A-8E illustrates various example view of a RVUI according to some embodiments.

### DETAILED DESCRIPTION OF EMBODIMENTS

The present embodiments will now be described more fully hereinafter. The present embodiments may, however, be embodied in many different forms and should not be construed as limited to the embodiments set forth herein; rather, these embodiments are provided by way of example so that this disclosure will be thorough and complete, and will fully convey the scope of the claims to those persons skilled in the art. Like reference numbers refer to like elements throughout the description.

As described earlier, conventional ways of controlling one or more functions of a recreational vehicle (RV) may be inadequate—in particular in view of today's and future needs that demand increasingly many functions to be controlled in said vehicle.

The inventors have realized that here is a need for an improved method and a corresponding user interface for controlling one or more functions in a recreational vehicle.

The same need has also been identified for recreational vessels such as yachts. In the following description, however, the aspects and embodiments will be described with reference to recreational vehicles (RVs).

To address the above-mentioned need, and in accordance with an aspect, described herein are a method implemented in a RVUI and a corresponding RVUI for controlling at least one function (i.e., one or several functions) of a recreational vehicle.

A circular-shaped user input element is displayed at a touchscreen of the RVUI. Furthermore, a user input is detected at the touchscreen of the RVUI. This user input comprises a movement along the displayed circular-shaped user input element. The movement is indicative of a request to control a user-selected function of the recreational vehicle. Responsive to detecting this user input, control of the user-selected function is initiated, or otherwise triggered. In some embodiments, a control signal representative of the user-selected function is transmitted, i.e. sent, to a processor for control of the user-selected function. The control signal may be transmitted wirelessly or over a wired connection.

As will be appreciate upon reading the following description, the RVUI may allow for controlling one or multiple functions of the RV flexibly. Additionally, or alternatively, the RVUI may allow for controlling one or multiple functions without inducing unnecessary complexity to a user who desires to control said function(s). The RVUI may additionally, or alternatively, allow for a user-friendly man-machine interaction when the user interacts and operates the RVUI to control various functions of the RV.

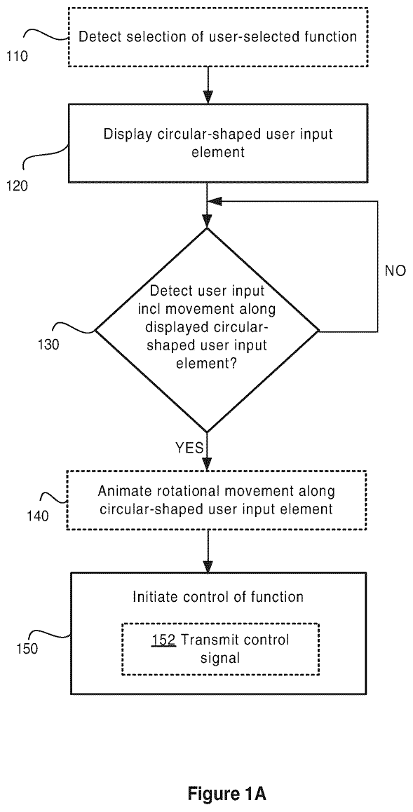

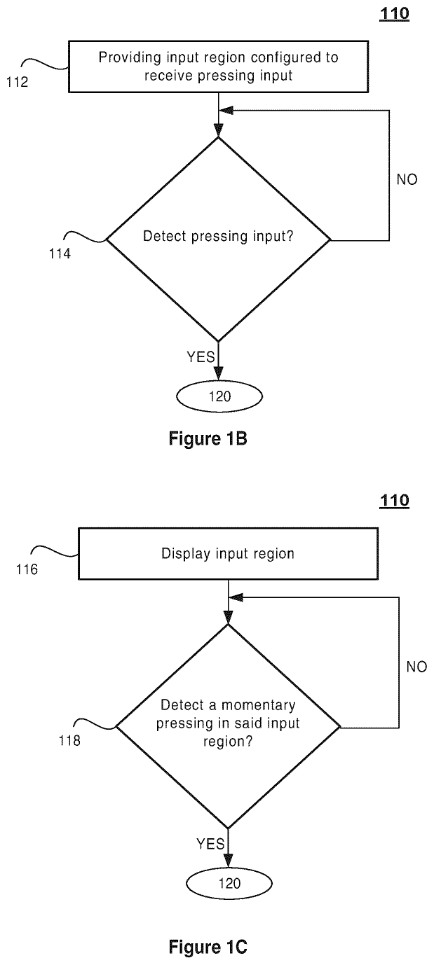

Reference is now made to FIGS. 1A-1C, which illustrate an example embodiment of a method.

It should be appreciated that the actions do not necessarily have to be performed, or otherwise executed, in the exact order as will be described in the following. However, in advantageous embodiments the actions may be performed in the exact order as described with reference to FIGS. 1A-1C.

Action 110: A selection of a user-selected function may be detected or otherwise sensed.

The user-selected function is a function of the RV to be controlled. The user-selected function may thus, for instance, include any one or a combination of a climate control function, a heater function, a ventilation function, a water heater function, a vehicle battery function, a light control function, and a security alarm function, etcetera.

FIGS. 1B and 1C illustrate two examples of the selection of a user-selected function in action 110. Reference is first made to FIG. 1B.

Action 112: One or more input regions may be provided. Each one of the one or more input regions may be associated with a selectable function. The input region(s) is/are physically depressible upon receiving the pressing input thereat. The input region(s) is/are also configured to receive a pressing input.

Action 114: A pressing input may be detected or otherwise sensed. The detection of a pressing input may be indicative of a request to select said user-selected function of the recreational vehicle, i.e. the function associated with the input region in question.

Reference is now made to FIG. 1C.

Action 116: One or more input regions may be displayed at the touchscreen of the RVUI. Each one of the one or more input regions may be associated with a selectable function.

Action 118: A momentary pressing may be detected or otherwise sensed at an input region. Responsive thereto, i.e. responsive to the detection of the momentary pressing at the input region in question, said user-selected function of the recreational vehicle (i.e., the function associated with the input region in question) is selected.

It should be appreciated that a momentary pressing is a pressing with a limited duration. In other words, a momentary pressing has a duration which is shorter than a maintained pressing. A maintained pressing is a pressing, which has a duration which is typically longer than a certain, e.g. pre-defined, threshold time period-such as longer than 1, 2 or 3 seconds. Therefore, a momentary pressing typically has a shorter duration than a corresponding duration of a maintained pressing-such as shorter than 1, 2 or 3 seconds. That is, if or when a maintained pressing is defined as a pressing with a duration of at least two seconds a corresponding momentary pressing would be defined as having a duration which is equal to or shorter than said two seconds. Similarly, if or when a maintained pressing is defined as a pressing with a duration of at least one second a corresponding momentary pressing would be defined as having a duration which is equal to or shorter than said one second. The momentary pressing may thus include a tap or a short press of the input region in question. Reference is now made to FIG. 1A again.

Action 120: A circular-shaped user input element is displayed at a touchscreen of the RVUI.

In some embodiments, action 120 may advantageously be made conditional on action 110. That is, action 120 is then only initiated responsive to a selection of a user-selected function having been detected or sensed in a previous action 110.

Action 130: It may be checked or otherwise determined whether a user input is detected or otherwise sensed at the touchscreen of the RVUI. Typically, but not necessarily, this is checked continuously.

As will be appreciated, a user input my thus be detected or otherwise sensed. This user input comprises a movement along the displayed circular-shaped user input element. The movement along the displayed circular-shaped user input element is indicative of a request to control a user-selected function of the recreational vehicle.

Action 140: Optionally, the rotational movement of the user input along the displayed circular-shaped user input element may be animated at the touchscreen of the RVUI in a manner that corresponds to the user movement. This has the advantage of providing the user with visual feedback, which credibly assists the user in his/her further interaction with the RVUI.

Additionally, or alternatively, the touchscreen may be configured to provide tactile feedback along the displayed circular-shaped user input element in a manner such that a user can sense his/her movement along the displayed circular-shaped user input element. The tactile feedback could, e.g., be implemented by using a vibration-creating device (e.g., a motor or the like) that is configured to create vibrations in response to user input in the form of the movement along the displayed circular-shaped user input element.

Action 150: Responsive to detecting said user input in action 130, control of the user-selected function is initiated or otherwise triggered.

Action 152: A control signal representative of the user-selected function may be transmitted, i.e. sent, to a processor for control of the user-selected function. Advantageously, the control signal may be transmitted to the processor wirelessly. Alternatively, the control signal may be transmitted to the processor via a wired connection.

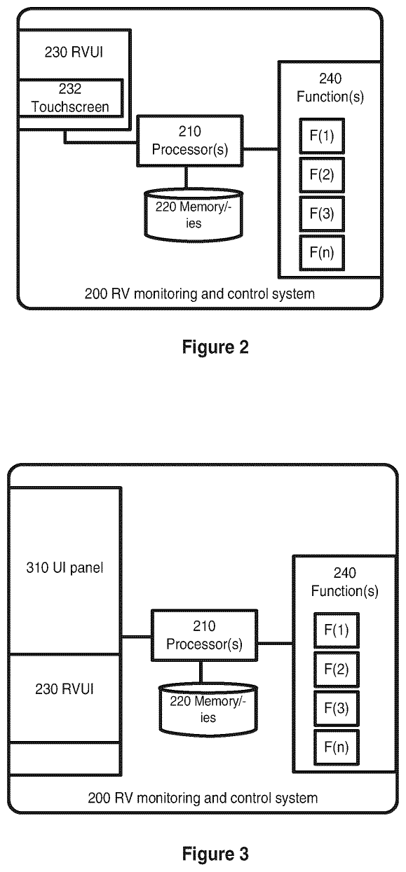

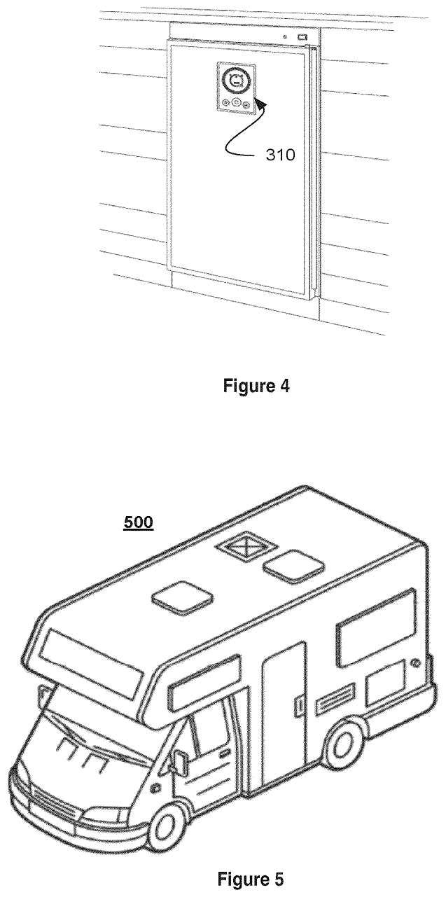

With reference to FIG. 2, an example implementation of a Recreational Vehicle User Interface (RVUI) 230 will now be described in further detail. The RVUI 230 is configured to control at least one function of a RV 500 (FIG. 5). The RVUI 230 of FIG. 2 may be operable to perform, or otherwise execute, the methods as described hereinabove with respect to FIGS. 1A-1C. As described earlier, RVs 500 are vehicles, which include living quarters for accommodation. Various types of RVs 500 include, e.g., a motorhome, a campervan, a caravan, a fifth-wheel trailer, a pop-up camper, or a truck camper. For example, the RVUI 230 may be part of a RV monitoring and control system 200 of a RV 500, such as a motorhome (see FIG. 5).

As is schematically illustrated in FIG. 2, a RV monitoring and control system 200 may comprise hardware resources 210, 220, 230, 240. For example, the RV monitoring and control system 200 may comprise one or more processors 210 and one or more memories 220. The RV monitoring and control system 200 may further comprise the RVUI 230. The RVUI 230 includes a touchscreen, i.e. a touch-sensitive display upon which virtual keys may be displayed and operated. Additionally, or alternatively, the RVUI 230 may be operable to issue and/or receive voice commands.

According to advantageous embodiments, the RVUI 230 comprises a touchscreen 232, which is configured to display a circular-shaped user input element. The touchscreen 232 is configured to detect, or otherwise sense, a user input comprising a movement along the displayed circular-shaped user input element, wherein the movement is indicative of a request to control a user-selected function 240 of the RV. The user-selected function 240 may for example be any one or a combination of: a climate control function F (1), a heater function F (2), a ventilation function F (3), a water heater function F (4), a vehicle battery function F (5), a light control function F (6), and a security alarm function F (7), etcetera. Furthermore, the RVUI 230 is configured to initiate control of the user-selected function responsive to detecting said user input.

Furthermore, the RVUI 230 may be configured to transmit a control signal representative of the user-selected function to the processor(s) 210 to control the user-selected function 240. For example, the RVUI 230 may be configured to transmit the control signal to the processor(s) 210 wirelessly, e.g., using any suitable short-range technology such as Bluetooth®, Wi-Fi, WiMax, ZigBee, Near-Field Communication (NFC), to name only a few examples. Additionally, or alternatively, the RVUI 230 may be configured to transmit the control signal to the processor(s) 210 via a wired connection. As will be appreciated, the memory/-ies 220 typically comprise(s) instructions executable by the processor(s) 210 whereby the RV monitoring and control system 200 is operative to control function(s) 240 of the RV.

In some embodiments, the touchscreen 232 of the RVUI 230 may advantageously be configured to animate rotational movement of the user input along the displayed circular-shaped user input element in a manner that corresponds to the user movement. Additionally, or alternatively, the touchscreen may be configured to provide tactile feedback along the displayed circular-shaped user input element in a manner such that a user can sense his/her movement along the displayed circular-shaped user input element. The tactile feedback could, e.g., be implemented by using a vibration-creating device (e.g., a motor or the like) that is configured to create vibrations in response to user input in the form of the movement along the displayed circular-shaped user input element.

In some embodiments, the RVUI 230 may include at least one input region configured to receive a pressing input. The at least one input region may be physically depressible upon receiving the pressing input thereat. This pressing input may for example be indicative of a request to select said user-selected function 240 of the RV 500. In some embodiments, the touchscreen 232 of the RVUI 230 may additionally, or alternatively, be configured to display at least one input region. The touchscreen 232 of the RVUI 230 may be configured to detect a momentary pressing at the at least one input region and responsive thereto to select said user-selected function of the RV. As described earlier herein, a momentary pressing is a pressing with a limited duration and may include a tap or a short press of the at least one input region.

Reference is now made to FIG. 3, which illustrates another embodiment. This embodiment is similar to the embodiment described in conjunction with FIG. 2. Like reference numbers therefore refer to like elements. All details will therefore not be repeated here. In the embodiment of FIG. 3, there is provided a user interface (UI) panel 310. The UI panel includes a RVUI 230 as described with reference to FIG. 2. As such, the UI panel 310 may be part of a RV monitoring and control system 200 for monitoring and controlling functions 240 of a RV 500 (FIG. 5).

Reference is now made to FIG. 4. FIG. 4 schematically illustrates an example where the UI panel 310 is attached to a surface of the RV 500 (FIG. 5). In some embodiments, the UI panel 310 may be removably attached to the surface of the RV 500. As will be appreciated, the RV 500 may hence comprise the UI panel 310.

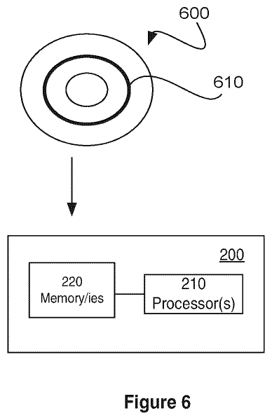

Turning now to FIG. 6, another aspect will be briefly discussed. FIG. 6 shows an example of a computer-readable medium, in this example in the form of a data disc 600. In one embodiment, the data disc 600 is a magnetic data storage disc. The data disc 600 is configured to carry instructions 610 that can be loaded into a data storage (e.g., memory (e.g. a Solid State Disc (SSD) memory)) of an apparatus (e.g., the RV monitoring and control system 200 in FIG. 3 or 4). Upon execution of said instructions by a processor of the apparatus, the apparatus is caused to execute a method or procedure as described in connection with FIGS. 1A-1C. The data disc 600 is arranged to be connected to or within and read by a reading device (not shown), for loading the instructions into the processor. One such example of a reading device in combination with one (or several) data disc(s) 600 is a hard drive. It should be noted that the computer-readable medium can also be other mediums such as compact discs, digital video discs, flash memories or other memory technologies commonly used. In such an embodiment, the data disc 600 is one type of a tangible computer-readable medium. The instructions may alternatively be downloaded to a computer data reading device, such as a computer or other media device capable of reading computer coded data on a computer-readable medium, by comprising the instructions in a computer-readable signal (not shown) which is transmitted via a wireless (or wired) interface (for example via the Internet) to the computer data reading device for loading the instructions into a processor of the apparatus. In such an embodiment, the computer-readable signal is one type of a non-tangible computer-readable medium.

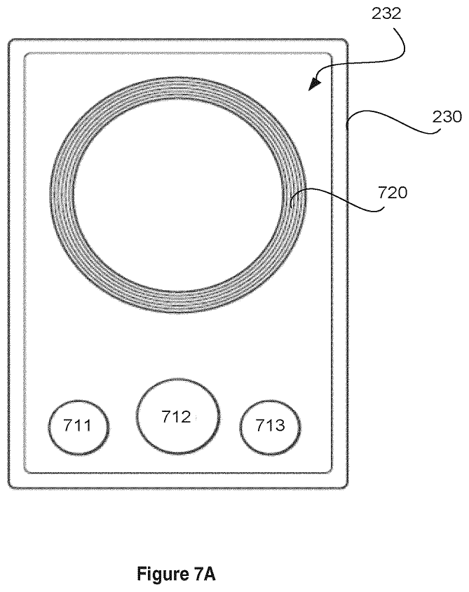

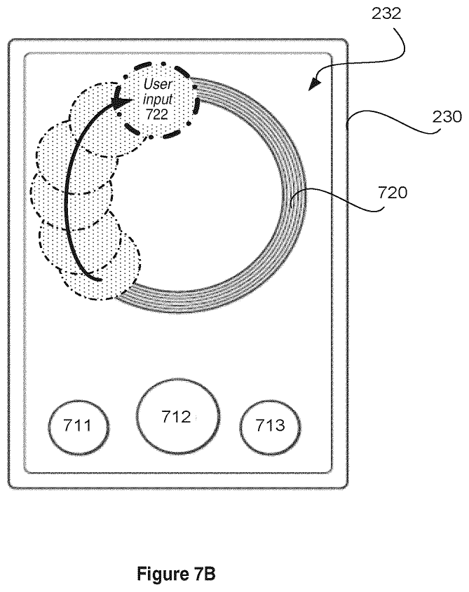

Reference will now be made to FIGS. 7A-7B, which illustrate various conceivable example embodiments of the RVUI 230 described hitherto.

In some embodiments, the RVUI 230 may be part of a user interface panel, which is removably attachable to a surface of a recreational vehicle, such as a motorhome, a campervan, a caravan, a fifth-wheel trailer, a pop-up camper, a truck camper.

The RVUI includes a touchscreen 232 as described earlier. As can be seen in FIG. 7A, the touchscreen 232 of the RVUI 232 may be configured to display one or more input regions 711, 712 and 713, e.g. displayed as virtual keys or buttons. Each one of the input regions 711, 712, 713 may, e.g., be configured to detect a momentary pressing at the input region in question and responsive thereto interpret the momentary pressing as a selection of a function associated with the thus pressed input region 711, 712, 713. Again, a momentary pressing is typically pressing with a limited duration as described earlier herein. The momentary pressing may thus include a tap or a short press of the input region in question. As will be appreciated, a user may thus interact with the RVUI 230 and issue requests by momentarily pressing an input region 711, 712, 713. In alternative embodiments, the input regions can instead be provided as physical keys or buttons. That is, the input regions are not necessarily provided as virtual keys or buttons of the touchscreen. The input region(s) may be configured to receive a pressing input, whereby the input region(s) is/are physically depressible upon receiving the pressing input thereat; wherein the pressing input is indicative of a request to select a function associated with the thus pressed input region.

The touchscreen 232 is configured to display a circular-shaped user input element 720. Reference is now also made to FIG. 7B, which schematically illustrates an exemplary user input movement 722 along at least part of the displayed circular-shaped user input element 720. The touchscreen 232 is configured to recognize user input 722 in the form of a movement, for example the movement of a user's finger (or a stylus) upon the touch-sensitive display (touchscreen) 232. A user may thus interact with the touchscreen 232 and provide user input 722, e.g., by moving the user's finger (or a stylus) along the displayed circular-shaped user input element 720. In other words, the touchscreen 232 is configured to sense or otherwise detect a user input 722 including a movement along at least part of the displayed circular-shaped user input element 720, wherein the movement along the displayed circular-shaped user input element is indicative of a request to control a user-selected function of the recreational vehicle. In response to sensing or otherwise detecting a user input 722, the RVUI 230 is configured to initiate control of the user-selected function.

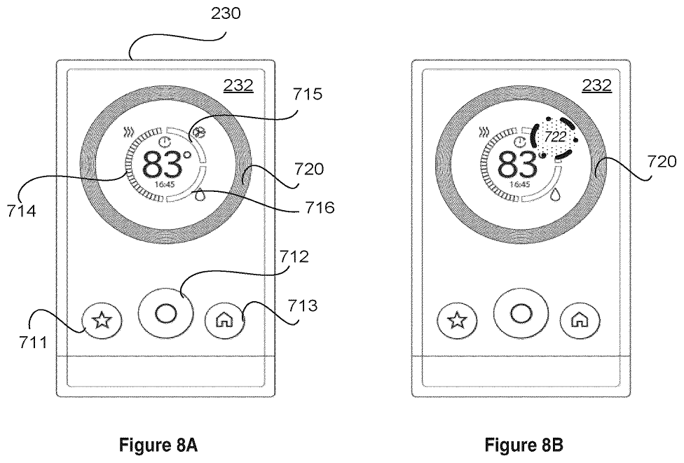

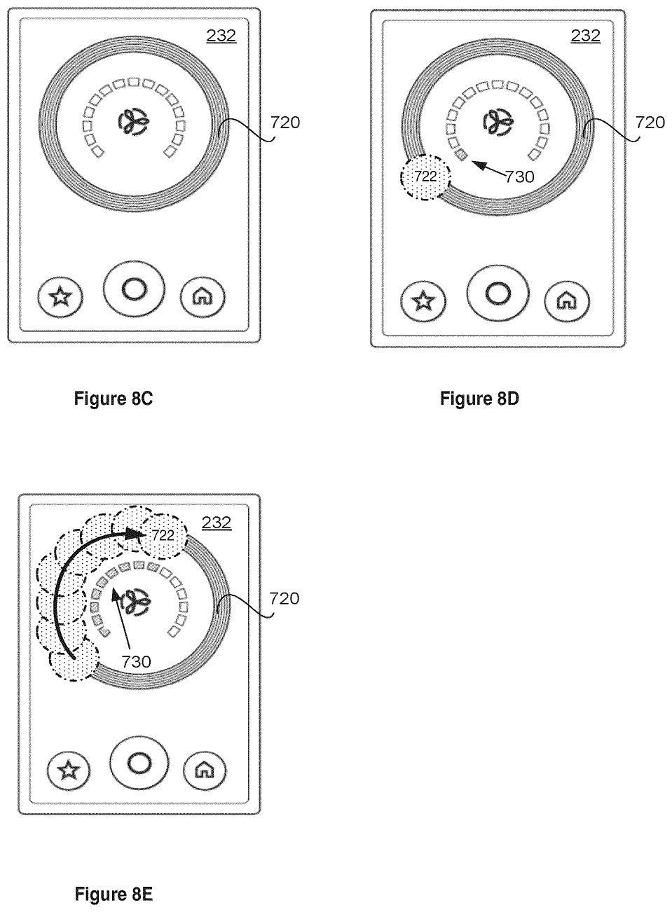

Reference is now made to FIGS. 8A-8E, which illustrate a sequence of actions when a user interacts with and operates an exemplary RVUI 230 as described in connection with FIGS. 7A-7B.

FIG. 8A schematically illustrates an example view of the RVUI 230. In this example, multiple input regions 711, 712, 713, 714, 715, 716 are provided. Each one of the input regions 711-716 may, e.g., be configured to detect a momentary pressing at the input region in question and responsive thereto interpret the momentary pressing as a selection of a function associated with the thus pressed input region 711-716. Again, a momentary pressing is typically pressing with a limited duration as described earlier herein. The momentary pressing may thus include a tap or a short press of the input region 711-716 in question. As will be appreciated, a user may thus interact with the RVUI 230 and issue requests by momentarily pressing any one of the input regions 711-716.

For example, and with reference to FIG. 8B, a user may interact with the touchscreen 232 of the RVUI 230 by momentarily pressing 722 the input region, or input area, 715 to select a function of the RV to be controlled, here exemplified by a fan function. For example, the touch screen 232 may be configured to detect a momentary pressing 722 at the input region 715 and responsive thereto interpret the momentary pressing as a selection of the fan function. The RVUI 230 may also be configured to transmit a control signal representative of the user-selected function, i.e. the fan function in this example, to a processor(s) 210 for continued control of the user-selected function. As described earlier, the control signal may be transmitted wirelessly or over a wired connection to the processor(s) 210. Furthermore, responsive to a user input (e.g. a tap) indicative of a request to select the fan function, the touchscreen may be configured to adjust or otherwise change the visual appearance of the display area 730 (FIG. 8C).

Reference is now made to FIG. 8C, which illustrates an exemplary visual appearance of the touchscreen 232 of the RVUI 230 when a user has selected the user-selected function —e.g., the fan function in this example. As can be seen in FIGS. 8B-8C, a user may interact with and operate the fan function by providing a user input 722 in the form of a movement along at least part of the displayed circular-shaped user input element 720. A movement along the displayed circular-shaped user input element 720 is indicative of a request to control the user-selected function, i.e. the fan function in this example, of the RV. Advantageously, but not necessarily, the touchscreen 232 of the RVUI 230 may be configured to animate 730 rotational movement of the user input along, or as in this example at, the displayed circular-shaped user input element in a manner that corresponds to the user movement. This gives the user who interacts with and operates the touchscreen visual feedback when the user controls the user-selected function, e.g. the fan function in this case. Responsive to detecting or sensing the user input, control of the user-selected function may be initiated or otherwise triggered accordingly. Furthermore, a control signal representative of the user-selected function may be transmitted, either wirelessly or over a wired connection, to a processor for control of the user-selected function in accordance with the user input at the touchscreen 232.

In FIGS. 8A-8E, the input region(s) 711, 712, 713 have been described to be, e.g., virtual keys or buttons. In alternative embodiments, it is conceivable to provide these input region(s) 711, 712, 713 in the form of physical buttons, which are configured to receive a pressing input.

The various aspects and embodiments provide an improved method and a corresponding RVUI for controlling one or several functions of a recreational vehicle. Some aspects and embodiments allow for controlling one or multiple functions of the RV flexibly. For example, some aspects and embodiments allow for controlling one or multiple functions without inducing unnecessary complexity to a user who desires to control said function(s). Compared to the existing art, the proposed embodiments and aspects may be perceived as more user-friendly by some users. For example, the proposed embodiments may be perceived as user-friendly in that they allow the control of many functions from one single location, the RVUI. This also enables a more time efficient way of controlling multiple functions-instead of requiring a user to move to the different physical buttons within the RV to control the different functions of the RV. Still further, the proposed embodiments and aspects are intuitive in that the user can receive visual feedback and can confirm that the desired functions are selected and controlled in a desired manner. Moreover, the RVUI may be part of a user interface panel which can advantageously be positioned, or placed, at a desired and thus easily accessible place, e.g. at a structure of the user's choice. In addition, and in contrast to physical buttons or rotatable knobs which are sometimes used in the prior art, a circular-shaped input element displayed at a touchscreen of the RVUI is more resistant towards wear damages.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while the embodiments have been described with reference to recreational vehicles, persons skilled in the art will appreciate that the embodiments may equivalently be applied to recreational vessels as is outlined below in the list of numbered example embodiments. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference signs in the claims are provided merely as a clarifying example and should not be construed as limiting the scope of the claims in any way.

### NUMBERED EXAMPLE EMBODIMENTS

The technology described throughout this disclosure thus encompasses without limitation the following numbered example embodiments:

NEE1. A method implemented in a Recreational Vehicle User Interface (RVUI), for controlling at least one function of a recreational vehicle, the method comprising:
displaying, at a touchscreen of the RVUI, a circular-shaped user input element; and
detecting, at the touchscreen of the RVUI, a user input comprising a movement along the displayed circular-shaped user input element, the movement being indicative of a request to control a user-selected function of the recreational vehicle; and responsive to detecting said user input initiating control of the user-selected function.

NEE2. The method according to embodiment NEE1, comprising:

transmitting a control signal representative of the user-selected function to a processor for control of the user-selected function.

NEE3. The method according to embodiment NEE2, wherein the control signal is transmitted to the processor wirelessly.

NEE4. The method according to any one of the embodiments NEE1-NEE3, comprising:
animating, at the touchscreen of the RVUI, rotational movement of the user input along the displayed circular-shaped user input element in a manner that corresponds to the user movement.

NEE5. The method according to any one of the embodiments NEE1-NEE4, wherein the user-selected function includes any one or a combination of: a climate control function, a heater function, a ventilation function, a water heater function, a vehicle battery function, a light control function, and a security alarm function.

NEE6. The method according to any one of the embodiments NEE1-NEE5, wherein the user-selected function is selected prior to the detecting of said user input.

NEE7. The method according to embodiment NEE6, comprising:
providing, at the RVUI, at least one input region configured to receive a pressing input, the at least one input region being physically depressible upon receiving the pressing input thereat; wherein
detecting a pressing input being indicative of a request to select said user-selected function of the recreational vehicle.

NEE8. The method according to embodiment NEE6, comprising:
displaying, at the touchscreen of the RVUI, at least one input region; and
detecting a momentary pressing at the at least one input region and responsive thereto selecting said user-selected function of the recreational vehicle.

NEE9. The method according to embodiment NEE8, wherein the momentary pressing includes a tap or a short press of the at least one input region.

NEE10. A Recreational Vehicle User Interface (RVUI) for controlling at least one function of a recreational vehicle, the RVUI comprising:
a touchscreen configured to display a circular-shaped user input element; wherein
the touchscreen is configured to detect a user input comprising a movement along the displayed circular-shaped user input element, the movement being indicative of a request to control a user-selected function of the recreational vehicle; and wherein
the RVUI is further configured to initiate control of the user-selected function responsive to detecting said user input.

NEE11. The RVUI according to embodiment NEE10, wherein the RVUI is configured to transmit a control signal representative of the user-selected function to a processor for control of the user-selected function.

NEE12. The RVUI according to embodiment 11, wherein the RVUI is configured to transmit the control signal to the processor wirelessly.

NEE13. The RVUI according to any one of the embodiments NEE10-NEE12, wherein the touchscreen is configured to animate rotational movement of the user input along the displayed circular-shaped user input element in a manner that corresponds to the user movement.

NEE14. The RVUI according to any one of the embodiments NEE10-NEE13, wherein the user-selected function includes any one or a combination of: a climate control function, a heater function, a ventilation function, a water heater function, a vehicle battery function, a light control function, and a security alarm function.

NEE15. The RVUI according to any one of the embodiments NEE10-NEE14, comprising:
at least one input region configured to receive a pressing input, the at least one input region being physically depressible upon receiving the pressing input thereat; wherein
the pressing input is indicative of a request to select said user-selected function of the recreational vehicle.

NEE16. The RVUI according to any one of the embodiments NEE10-NEE14, wherein
the touchscreen of the RVUI is configured to display at least one input region; wherein
the touchscreen of the RVUI is further configured to detect a momentary pressing at the at least one input region and responsive thereto to select said user-selected function of the recreational vehicle.

NEE17. The RVUI according to embodiment NEE16, wherein momentary pressing includes a tap or a short press of the at least one input region.

NEE18. A user interface panel comprising the RVUI according to any one of the embodiments NEE10-NEE17, wherein the user interface panel is attachable to a surface of the recreational vehicle.

NEE19. A recreational vehicle comprising the user interface panel according to embodiment NEE18.

NEE20. The recreational vehicle according to embodiment NEE19, wherein the recreational vehicle is a recreational vehicle selected from the group consisting of: a motorhome, a campervan, a caravan, a fifth-wheel trailer, a pop-up camper, a truck camper.

NEE21. Computer program, comprising instructions which, when executed on at least one processor, cause the at least one processor to carry out the method according to any one of the embodiments NEE1-NEE9.

NEE22. A carrier comprising the computer program of embodiment NEE20, wherein the carrier is one of an electronic signal, optical signal, radio signal or non-transitory computer readable storage medium.

NEE23. A method implemented in a Recreational Vessel User Interface (RVUI), for controlling at least one function of a recreational vessel, the method comprising:
displaying, at a touchscreen of the RVUI, a circular-shaped user input element; and
detecting, at the touchscreen of the RVUI, a user input comprising a movement along the displayed circular-shaped user input element, the movement being indicative of a request to control a user-selected function of the recreational vessel; and responsive to detecting said user input
initiating control of the user-selected function.

NEE24. The method according to embodiment NEE23, comprising:
transmitting a control signal representative of the user-selected function to a processor for control of the user-selected function.

NEE25. The method according to embodiment NEE24, wherein the control signal is transmitted to the processor wirelessly.

NEE26. The method according to any one of the embodiments NEE23-NEE25, comprising: animating, at the touchscreen of the RVUI, rotational movement of the user input along the displayed circular-shaped user input element in a manner that corresponds to the user movement.

NEE27. The method according to any one of the embodiments NEE23-NEE26, wherein the user-selected function includes any one or a combination of: a climate control function, a heater function, a ventilation function, a water heater function, a vessel battery function, a light control function, and a security alarm function.

NEE28. The method according to any one of the embodiments NEE23-NEE27, wherein the user-selected function is selected prior to the detecting of said user input.

NEE29. The method according to embodiment NEE28, comprising:
providing, at the RVUI, at least one input region configured to receive a pressing input, the at least one input region being physically depressible upon receiving the pressing input thereat; wherein
detecting a pressing input being indicative of a request to select said user-selected function of the recreational vessel.

NEE30. The method according to embodiment NEE28, comprising:
displaying, at the touchscreen of the RVUI, at least one input region; and
detecting a momentary pressing at the at least one input region and responsive thereto selecting said user-selected function of the recreational vessel.

NEE31. The method according to embodiment NEE29, wherein the momentary pressing includes a tap or a short press of the at least one input region.

NEE32. A Recreational Vessel User Interface (RVUI) for controlling at least one function of a recreational vessel, the RVUI comprising:
a touchscreen configured to display a circular-shaped user input element; wherein
the touchscreen is configured to detect a user input comprising a movement along the displayed circular-shaped user input element, the movement being indicative of a request to control a user-selected function of the recreational vessel; and wherein
the RVUI is further configured to initiate control of the user-selected function responsive to detecting said user input.

NEE33. The RVUI according to embodiment NEE32, wherein the RVUI is configured to transmit a control signal representative of the user-selected function to a processor for control of the user-selected function.

NEE34. The RVUI according to embodiment NEE33, wherein the RVUI is configured to transmit the control signal to the processor wirelessly.

NEE35. The RVUI according to any one of the embodiments NEE32-NEE34, wherein the touchscreen is configured to animate rotational movement of the user input along the displayed circular-shaped user input element in a manner that corresponds to the user movement.

NEE36. The RVUI according to any one of the embodiments NEE32-NEE35, wherein the user-selected function includes any one or a combination of: a climate control function, a heater function, a ventilation function, a water heater function, a vessel battery function, a light control function, and a security alarm function.

NEE37. The RVUI according to any one of the embodiments NEE32-NEE36, comprising:
at least one input region configured to receive a pressing input, the at least one input region being physically depressible upon receiving the pressing input thereat; wherein
the pressing input is indicative of a request to select said user-selected function of the recreational vessel.

NEE38. The RVUI according to any one of the embodiments NEE32-NEE37, wherein
the touchscreen of the RVUI is configured to display at least one input region; wherein
the touchscreen of the RVUI is further configured to detect a momentary pressing at the at least one input region and responsive thereto to select said user-selected function of the recreational vessel.

NEE39. The RVUI according to embodiment NEE38, wherein momentary pressing includes a tap or a short press of the at least one input region.

NEE40. A user interface panel comprising the RVUI according to any one of the embodiments NEE32-NEE39, wherein the user interface panel is attachable to a surface of the recreational vessel.

NEE41. A recreational vessel comprising the user interface panel according to embodiment NEE40.

NEE42. The recreational vessel according to embodiment NEE41, wherein the recreational vessel is a recreational vessel selected from the group consisting of: a sailing yacht, and a motor yacht.

NEE43. Computer program, comprising instructions which, when executed on at least one processor, cause the at least one processor to carry out the method according to any one of the embodiments NEE23-NEE30.

NEE44. A carrier comprising the computer program of embodiment NEE43, wherein the carrier is one of an electronic signal, optical signal, radio signal or non-transitory computer readable storage medium.

1. A method implemented in a Recreational Vehicle User Interface, RVUI, of a RV monitoring and control system, which is operable to control at least one function of a recreational vehicle, the method comprising:
displaying, at a touchscreen of the RVUI, a user input element and at least one input region positioned below the user input element in a vertical direction; and
detecting, at the touchscreen of the RVUI, a user input comprising a movement along the displayed user input element, the movement being indicative of a request to control a user-selected function of the recreational vehicle, the touchscreen is further configured to provide tactile feedback along the displayed user input element such that a user can sense the user's movement along the displayed user input element in response to user input in the form of the movement along the displayed user input element; and
responsive to detecting said user input, initiating control of the user-selected function via the control system to operably control the user-selected function.

2. The method according to claim 1, wherein the user-selected function includes any one or a combination of: a climate control function, a heater function, a ventilation function, a water heater function, a vehicle battery function, a light control function, and a security alarm function.

3. The method according to claim 1, wherein the tactile feedback being implemented is by a vibration-creating device configured to create vibrations in response to user input in the form of the movement along the displayed user input element.

4. The method according to claim 1, comprising:
transmitting a control signal representative of the user-selected function to a processor for control of the user-selected function.

5. The method according to claim 1, wherein the user input element is displayed as a circular-shaped user input element.

6. The method according to claim 5, comprising:
animating, at the touchscreen of the RVUI, rotational movement of the user input along the displayed circular-shaped user input element in a manner that corresponds to the user movement.

7. The method according to claim 1, wherein:
the touchscreen in the at least one input region is configured to receive a pressing input, the at least one input region being physically depressible upon receiving the pressing input thereat,
wherein detecting the pressing input being indicative of a request to select said user-selected function of the recreational vehicle.

8. The method according to claim 1, wherein the touchscreen is configured to detect a momentary pressing at the at least one input region and responsive thereto selecting said user-selected function of the recreational vehicle.

9. The method according to claim 1, wherein the user-selected function is selected prior to the detecting of said user input.

10. The method according to claim 1, wherein the at least one input region includes a plurality of sub-input regions within an area of the at least one input region.

11. A Recreational Vehicle User Interface, RVUI, of a RV monitoring a control system, which is operable to control at least one function of a recreational vehicle, the RVUI comprising:
a touchscreen configured to display a user input element and at least one input region positioned below the user input element in a vertical direction; wherein
the touchscreen is configured to detect a user input comprising a movement along the displayed user input element, the movement being indicative of a request to control a user-selected function of the recreational vehicle, the touchscreen is further configured to provide tactile feedback along the displayed user input element such that a user can sense the user's movement along the displayed user input element in response to user input in the form of the movement along the displayed user input element; and
the RVUI is further configured to initiate control of the user-selected function responsive to detecting said user input via the control system to operably control the user-selected function.

12. The RVUI according to claim 11, wherein the user-selected function includes any one or a combination of: a climate control function, a heater function, a ventilation function, a water heater function, a vehicle battery function, a light control function, and a security alarm function.

13. The RVUI according to claim 11, wherein the tactile feedback is being implemented by a vibration-creating device configured to create vibrations in response to user input in the form of the movement along the displayed user input element.

14. The RVUI according to claim 11, wherein the RVUI is configured to transmit a control signal representative of the user-selected function to a processor for control of the user-selected function.

15. The RVUI according to claim 11, wherein the user input element is displayed as a circular-shaped user input element.

16. The RVUI according to claim 15, wherein the touchscreen is configured to animate rotational movement of the user input along the displayed circular-shaped user input element in a manner that corresponds to the user movement.

17. The RVUI according to claim 11 wherein:
the touchscreen is configured to receive a pressing input in the at least one input region such that the at least one input region being physically depressible upon receiving the pressing input thereat,
wherein the pressing input is indicative of a request to select said user-selected function of the recreational vehicle.

18. The RVUI according to claim 11, wherein the touchscreen of the RVUI is configured to detect a momentary pressing at the at least one input region and responsive thereto to select said user-selected function of the recreational vehicle.

19. The RVUI according to claim 11, wherein the at least one input region includes a plurality of sub-input regions within an area of the at least one input region.

20. A user interface panel comprising the RVUI according to claim 11, wherein the user interface panel is attachable to a surface of the recreational vehicle.
